(19) United States
(12) Patent Application Publication
(10) Pub. No.: US 2017/0373534 A1
(43) Pub. Date: Dec. 28, 2017

(54) METHOD AND APPARATUS FOR DETERMINING ENERGY SAVINGS

(71) Applicant: Embertec Pty Ltd, Dulwich, South Australia (AU)

(72) Inventors: Domenico Gelonese, Dulwich, South Australia (AU); Riccardo Gatto, Dulwich, South Australia (AU)

(21) Appl. No.: 15/544,075

(22) PCT Filed: Jan. 15, 2016
(86) PCT No.: PCT/AU2016/000005

§ 371 Date: Jul. 17, 2017

(30) Foreign Application Priority Data
Jan. 20, 2015 (AU) 2015900148
Jan. 30, 2015 (AU) 2015900280
Jun. 18, 2015 (AU) 2015902340
Nov. 9, 2015 (AU) 2015904599

(51) Int. Cl. H02J 13/00; H04W 4/00; H01R 25/00; G06F 11/30; G06F 3/06; H04W 84/12; G06F 1/32

(52) U.S. Cl. CPC H02J 13/001; H04W 84/12; H04W 4/008; G06F 1/3203; G06F 11/3062; G06F 3/0673; H01R 25/003

(57) ABSTRACT

A method for evaluation, measurement and verification of energy savings achieved by an installation of an energy saving device, such as an advanced power strip or energy hub device. The method includes an installer installing an energy saving device in a premises supplied with electricity by an energy supplier. Installation information is recorded and to a monitoring entity, usage data describing the ongoing use and power consumption of the energy saving device is then transmitted to the monitoring entity.

### TECHNICAL FIELD

This invention relates to a system and method and apparatus of for installation of an advanced power strip including evaluation, measurement and verification of installation and energy savings.

### BACKGROUND OF THE INVENTION

The following references to and descriptions of prior proposals or products are not intended to be and are not to be construed as statements or admissions of common general knowledge in the art. In particular, the following prior art discussion does not relate to what is commonly or well known by the person skilled in the art, but may assist in the understanding of the inventive step of the present invention, of which the identification of pertinent prior proposals is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households is the audio visual equipment, including multiple devices such as televisions, television decoders, television recorders and sound equipment, now found in the great majority of homes.

Efforts have been made to reduce or control the use of energy by television receivers and associated audio visual equipment, in particular with the use of standby power controllers or advanced power strips, and these have met with considerable success.

Standby power supply control devices are often included as part of energy saving incentives backed by such sponsoring entities as energy retailers, energy distributors, energy generators and government bodies. Incentives, which may be free or subsidised supply of the devices, reductions in power bills or any other acceptable incentive, are provided by the entity to a consumer in an attempt to encourage the consumer, be they domestic or commercial, to acquire such devices and to install the devices in a manner such that a reduction in energy use by the consumer is likely to occur.

However, the sponsor wishes to know after installation what energy savings have actually been achieved by the installation. This may be to evaluate whether such installations are effective for future planning or, in the case where payment of incentives is ongoing, to determine whether incentive payments for a particular installation should continue.

### DISCLOSURE OF THE INVENTION

Accordingly, in a first aspect this invention may be said to reside in a method for evaluation, measurement and verification of energy savings achieved by an installation of an energy saving device.

In preference, the invention may be said to lie in a method for determining energy savings brought about by installation of an energy saving device. The method includes an installer installing an energy saving device in a premises supplied with electricity by an energy supplier where the electricity is for the benefit of an account holder and the energy saving device installation is done for that account holder.

A funding entity contributes to the cost of the installation. The funding entity is an entity such as an energy retailer, energy distributor, energy generator or government entity having an interest in the installation of energy saving devices. In general, the funding entity is not the owner or occupant of the premises.

In a further step, it is verified that the energy saving device has been correctly installed in compliance with requirements of a funding entity.

The method further includes recording installation information describing the installation and transmitting said installation information to a monitoring entity and transmitting usage data describing the ongoing use and power consumption of the energy saving device to the monitoring entity.

In preference, the method further includes discovering and recording premises information describing the premises and transmitting said premises information to the monitoring entity.

The premises information is used to determine any one or more of the identity of the account holder and the identity of an energy supplier to the premises.

In preference, the usage data is analysed by the monitoring entity to verify that the energy saving device is bringing about the level of energy savings expected by the funding entity and the monitoring entity reports these results to the funding entity.

In preference the results of the analysis are used by the funding entity to determine the amount of one or more payments to one or more of the installer, the account holder and the monitoring entity.

In preference the analysis of the usage data is applied to a number of installations and the results of the analysis are used to determine the success of a program of installations paid for at least in part by the funding entity.

In preference the energy saving device is an advanced power strip (APS).

In preference, in the alternative, the energy saving device is an energy hub device.

In preference the energy saving device communicates with the monitoring entity at least in part via a Bluetooth wireless link.

In preference the energy saving device communicates with the monitoring entity at least in part via a wi-fi wireless link, using a wi-fi network available in the premises.

In preference the energy saving device communicates with the monitoring entity at least in part via a mesh network wireless link.

In a further form the invention may be said to lie in an advanced power strip including a data link adapted to permit communication with an external monitoring entity.

In preference the data link includes one or more of a Bluetooth link, wi-fi link and a wired connection.

### BRIEF DESCRIPTION OF THE DRAWINGS

The invention will now be described with reference to certain non-limiting embodiments in connection with the accompanying drawings in which:

FIG. 1 shows a representation of an APS including an embodiment of the current invention.

FIG. 2 shows a flowchart of the installation of an energy saving device, where the installation is undertaken by a dedicated installer.

FIG. 3 shows a flowchart of the ongoing measurement and verification of performance of an installed energy saving device.

FIG. 4 shows a flowchart of the installation of an energy saving device, where the installation is undertaken by a premises occupant, in the illustrated case, a householder.

### DETAILED DESCRIPTION OF THE DRAWINGS

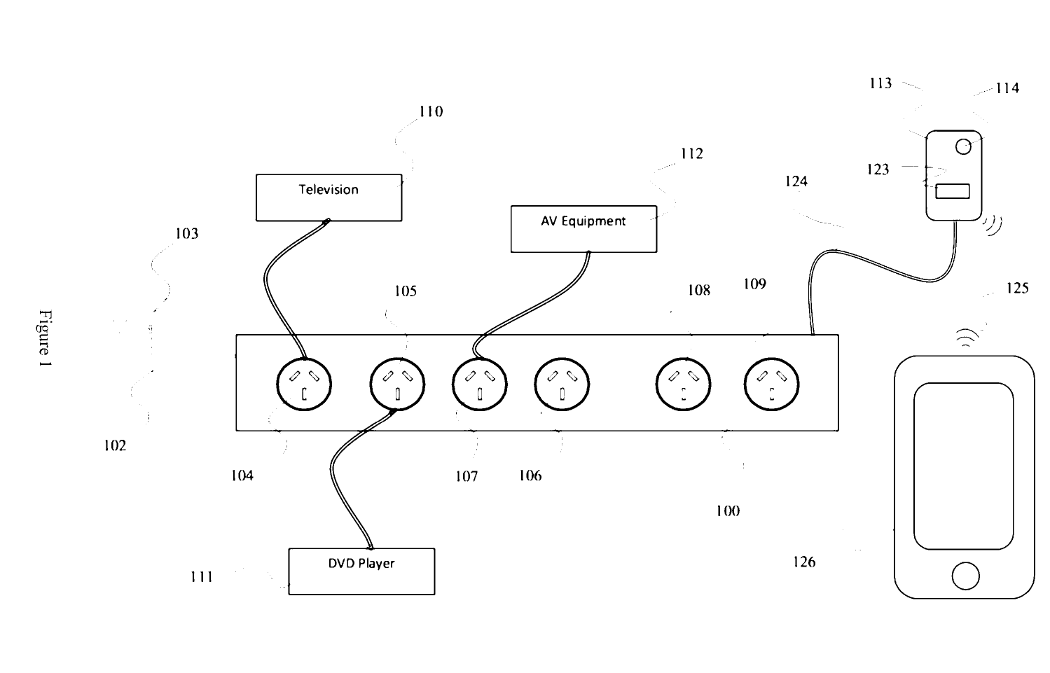

Referring first to FIG. 1, it is to be understood that this is a general representation of an installation including an Advanced Power Strip (APS) including the invention and is illustrative only. It is not intended to limit the number or configuration of continually powered or switched or monitored mains outlets, or of communication interfaces or other functional modules.

FIG. 1 shows a representation of an advanced power strip (APS) including an embodiment of the current invention. An APS, which may also be known as a standby power controller (SPC), is a multi-outlet power tap which includes functionality to measure characteristics of the power being drawn by an appliance or appliances plugged in to the power strip, and to analyse or facilitate the analysis of those characteristics.

The result of the analysis may be used to cut power to an appliance or appliances when the analysis shows that the appliance is not in use or is likely not to be in use.

An APS controls the flow of electrical power to one or more of the connected appliances such that when one or more, or a particular one, of the connected appliances is in a “standby” state where it is not being used, the electrical power supply to one, all or selected ones of the connected appliances is interrupted.

The APS 100 receives electrical power from a General Purpose Outlet 103, via power cord 102.

The APS includes Monitored and Controlled Outlets 104,105,106, 107. The APS also includes Uncontrolled Outlets 108, 109. In general, any number of Monitored and Controlled outlets and Uncontrolled Outlets may be provided. In an embodiment, the Uncontrolled outlet may be absent.

Monitored and Controlled Outlet 104 supplies electrical power to a television 110. Further Monitored and Controlled Outlets 105, 106 may provide electrical power to other audio-visual equipment, for example a DVD player 111 and audio equipment 112. In an embodiment having only one Monitored and Controlled outlet, multiple devices may be powered from the one outlet using a powerstrip. In any embodiment, multiple devices may be powered from one Monitored and Controlled outlet using a powerstrip.

The APS includes a Sensing and Communications Unit 113. In a preferred embodiment, this unit is in data communication with the body of the APS via cable 124, which may also provide power to the Sensing and Communications Unit 113.

The Sensing and Communications Unit 113 also includes a remote communication means, in the illustrated embodiment a Bluetooth transceiver 123. The cable 124 may be a fixed connection or may be plug connected at one or both ends. In a further embodiment, the Sensing and Communications Unit may be integrated with the APS body. In further embodiments, the remote communication means may be provided by any convenient wireless protocol, including without limitation, wifi, zigbee and RF4CE.

Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy.

The APS may detect that the television has entered a standby state by any convenient means or combination of means.

In order to save energy the APS operates to remove the power supply from Monitored and Controlled outlet 104 and hence from the attached television, whenever the television is detected to not be in use.

The APS may also include a power sensor adapted to sense the power drawn through a Monitored and Controlled outlet. The power sensor detects characteristics of the power flow through the outlet. When the characteristic is such as to indicate that the television is in a standby mode the power to the Monitored and Controlled outlet 104, and hence to the attached television or monitor is interrupted.

The APS may include any number of Monitored and Controlled outlets, which may be monitored and controlled individually or together. When Monitored and Controlled Outlet 104 has power interrupted, none, some or all other Monitored and Controlled Outlets will also have power supply cut.

The APS in the illustrated embodiment includes an Active Powerdown feature. Such a feature is optional. An APS with Active Powerdown includes means to detect that a user is interacting with the audio visual equipment and/or the television. In the illustrated embodiment, the sensing and communications unit 113 includes an infra-red sensor 114. This sensor 114 receives IR signals from a remote control associated with the television or other connected AV equipment.

It is likely that a user, when actively watching television, will periodically use the remote control to change channels, adjust volume, mute commercials, etc. Thus a remote control signal receiver, such as IR sensor 114 can be used as a usage sensor. If no remote control activity is detected by the IR sensor 114 for a period of time, the assumption may be made that the television is not in use, and the power supply to the Monitored and Controlled outlet 104, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television is assumed to not be in active use and the electricity supply to the Monitored and Controlled outlet 104, and hence to the television, is interrupted. When Monitored and Controlled Outlet 104 has power interrupted, none, some or all other Monitored and Controlled Outlets will also have power supply cut. This is Active Powerdown whereby power is removed from a device which is not in a low power standby state, but has nonetheless been determined not to be in active use.

It may be sufficient to determine that a user is present in the vicinity of the television in order to decide that the television should not be turned off. Any suitable sensor may be used for determining that a user is present and thus that power to the television should not be interrupted. These include, without limitation, passive IR sensors, ultrasonic sensors, cameras, any other passive or active movement sensors, and sound detectors.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the power control function of the APS being bypassed, or the APS being removed, reducing or eliminating power savings.

The APS may include a warning LED. When the APS determines that the television is in active standby, the warning LED will flash to alert any user to the imminent shutdown of the power to the television. In the case where there is a false positive, that is, there is a user watching the television, the user may react to observing the flashing of the warning LED by pressing a key on the remote control. The IR signal from the remote control is detected by the IR sensor 114, and the countdown timer is reset, preventing the power to the television being interrupted.

Other methods for warning of imminent shutdown of power to the television may be used. An audible warning tone may sound.

The APS may include software allowing control of the warning mechanism. The brightness of the LED may be variable. It may be possible to set times when the warning should take certain forms. For example, an audible warning may be used at certain times of the day, whilst the LED is used at other times. At still further times, no warning at all may be given.

Uncontrolled power outlets 108, 109 are optionally provided to allow for power to be supplied to devices which should not have the power supply cut when the television is not in use. This outlet supplies power at all times when the APS is plugged in. Any number of uncontrolled outlets may be provided.

Devices other than a television may be connected along with a television to the Monitored and Controlled outlets. In this case, the total load of all devices will be monitored for the characteristics indicating that all devices so connected are in a standby or unused state.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the monitored, controlled outlet 108, power is also interrupted to this outlet.

The remote communication means provides a data link to processing devices external to the APS. An external device may provide a user interface for the APS, enabling a user to monitor and/or control some functions of the APS.

There is provided Bluetooth transceiver 123 which provides data link 125 to an external processing device, in the illustrated embodiment, a smartphone 126. In other embodiments, without limitation, the processing device may be a tablet computer or any other mobile computing device, or a desktop computer. In other embodiments, any other suitable wired or wireless protocol may be used to provide the data link 125.

The smartphone 126 runs a program (an App) which provides a user interface for the APS. This user interface allows a user to control settings of the APS. Settings may include the countdown time before power is removed when no IR activity is detected. The user interface may also be used to activate and deactivate the power saving functions of the APS.

The APS monitors the power drawn through each, or all of the Monitored and Controlled Outlets. This data is transmitted via the data link 125 to the App running on the smartphone 126. This data records the amount of power drawn, and the time at which it was drawn. The APS may include a real-time clock to give actual time of power consumption, or may simply provide a relative time sequence of power readings from the monitoring of the Monitored and Controlled outlets.

The APS also records the details of the control of the Monitored and Controlled Outlets, that is, the times when the APS has acted to remove power from the controlled outlets.

This data concerning the operation of the APS and the equipment to which it provides power is usage data. This usage data is transmitted to the App via data link 125.

In general, the smartphone 126 will not be within Bluetooth range of the APS at all times. The data link 125 will be intermittently available. The APS or the App is able to create the link 125 when the devices are within range. The APS will then transmit the recorded usage data to the App.

The App is then able to make use of the internet connection of the smartphone 126 in order to transmit the usage data to a monitoring entity, as described further in this specification.

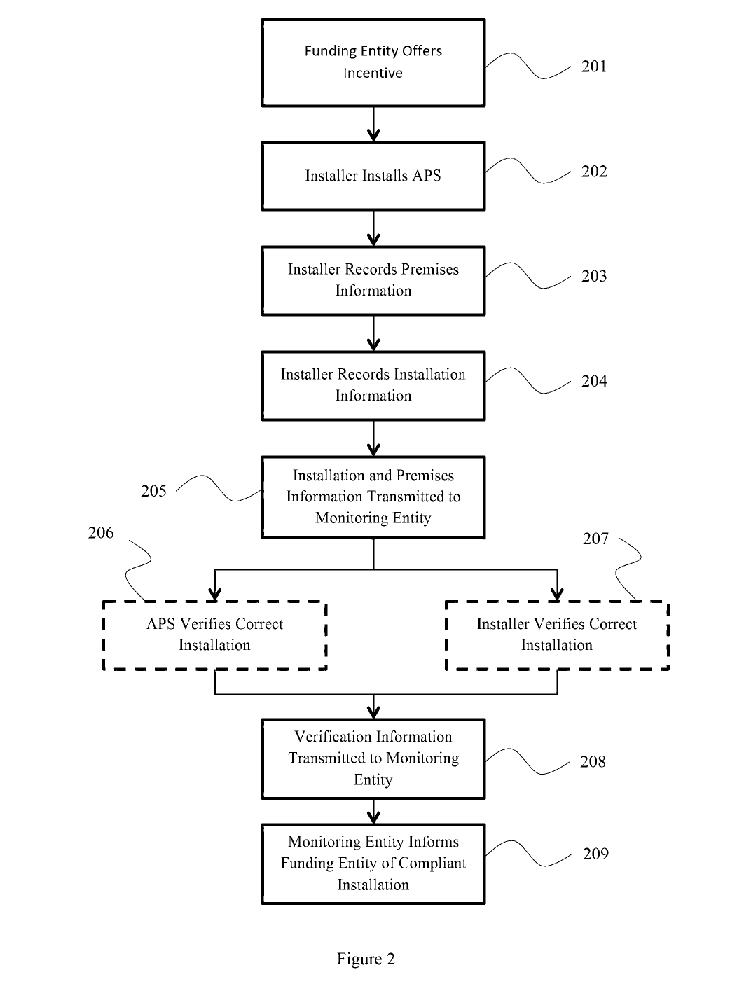

FIG. 2 shows a flowchart of the process for installation of an energy saving device in a premises. In the illustrated embodiment, the energy saving device is an advanced power strip, but other energy saving devices or systems may be installed in the same manner.

At 201 a funding entity offers an incentive for the installation of energy saving devices in premises, for example, households and light commercial premises.

A funding entity is an entity which provides funding to encourage the installation of energy saving devices in premises, generally premises not owned, operated or occupied by the funding entity. The funding entity may do this from a desire to save energy, or in order to comply with regulatory or contractual obligations placed upon it.

Without limitation, funding entities may include energy retailers, who may be required by regulators to implement energy saving programs to, for example, reduce greenhouse gas emissions. Entities responsible for electricity transmission may also fund installation of energy saving devices in order to reduce requirements to provide transmission capacity for peak loads. A government entity or energy regulator may wish to encourage installation of energy saving devices in order to provide assistance for low income households or to reduce greenhouse gas emissions.

At 202, an installer responds to the incentives offered by the funding entity by installing one or more APS in a premises. An installer may be an employee or contractor of the funding entity, or may be an independent entity making installations in order to receive the incentives. Incentives may be direct monetary payments. Incentives may be tradable certificates with a market created by a regulatory requirement for the funding entity to purchase certificates in order to meet energy saving or greenhouse gas reduction targets.

The installer negotiates with the premises account holder to allow the installation of the energy saving device. An account holder is the entity responsible for paying for the electricity supply to a premises.

The installer may gain access to the premises by directly approaching households and offering to install the energy saving devices. Alternatively, the installer may have access to details of account holders premises where the funding entity wishes to have energy saving devices installed.

Upon installation the installer records 203 premises information. This may be simply indicating that the premises is one where the funding entity is prepared to pay for the installation of an energy saving device. Where the installer has acquired the premises details by their own efforts, details indicating that the premises qualifies for funding may be required by the funding entity to be recorded. This may be done by the installer carrying a device such as a laptop computer with a GPS location capability, where the GPS co-ordinates of the installation premises are used to identify the premises. In addition or alternatively, the installer may obtain information such as the identity of the electricity supplier to the premises by questioning the householder. Information such as household size and make-up, and premises construction, may be acquired by asking the householder or by observation.

The installer will also record 204 the installation information, being, without limitation, details of the installation, such as the number and type of appliances which are connected to the APS and the number of APS installed in the premises. Specific identifiers for each individual APS, such as a serial number, may be recorded.

The installation and premises information is transmitted 205 to a monitoring entity.

A monitoring entity is an entity, external to a premises, which receives data from an energy saving device installed in the premises. The monitoring entity may analyse the data and make the results of the analysis available to third parties, for example, a funding entity. The monitoring entity may make the data received from the energy saving device available to the third party. A monitoring entity may also be an energy supplier, a funding entity or a government body. An energy supplier may be any entity associated with the supply of energy to the premises, including, without limitation, energy retailers, electricity generators and suppliers and operators of electricity transmission services.

The data transmission to the monitoring entity can be by any convenient means. In a preferred embodiment, the installer is equipped with a mobile computing device, such as a tablet computer or a smartphone, which is able to send and receive data via the mobile telephony network. This is used to send data to the monitoring entity in real or near-real time.

In an alternative embodiment, data communication to the monitoring entity may be batched. The installer records the require information on a mobile computing device. Data from a number of installations may be recorded over a period of time. At a later convenient time, this data is downloaded to the monitoring entity, either via a transmission link or by direct connection to the monitoring entity's computer or computer network. For example, the data may be recorded on a removable memory device such as a USB stick, and the USB stick subsequently attached to a computer belonging to the monitoring entity.

In further preferred embodiment, the APS is equipped to create a transmission link to the monitoring entity. The APS may create this link by creating a Bluetooth link to a Smartphone or other mobile computing device which has an internet connection. The mobile computing device will run software (an App) which allows the data from the APS to be sent to the monitoring entity via the internet. Alternatively, the APS may create the transmission link to the monitoring entity by using the existing wi-fi capability in the household, or by using a publicly available wireless internet access point.

The energy saving device may be such that installation in a particular manner is required in order to be eligible for the financial support of the funding entity. For example, without limitation, there may be a requirement that an eligible installation of an APS requires that more than one device, or specific types of devices draw power through the APS in order for the installation to be eligible for funding.

In an embodiment, the APS is equipped to verify that the installation is correct 206. The APS may do this by, without limitation, measuring current flow through the APS, by making such measurements before and/or after removing power from plugged in devices or by monitoring the power draw for an extended period of time.

In an alternative embodiment verification may be provided 207 by the installer. The installer ensures that the installation is compliant, which may involve testing the performance of the APS, then certifies that the installation is compliant.

The fact that a compliant installation has occurred, however verified, is then transmitted 208 to the monitoring entity.

The monitoring entity now informs 209 the funding entity of the compliant installation. Depending on the agreement between the monitoring entity and the funding entity, premises information and/or installation information may be passed to the funding entity.

The funding entity responds to the indication of a successful installation by providing the incentive which it offered for such an installation.

A significant issue with the funding of the installation of energy saving devices by funding entities is the uncertainty around the exact energy savings made by the device, and the persistence of these savings. The degree of funding provided for each installation has usually been related to so-called “deemed savings”. Based on indirect measures such as trials, simulations and mathematical models, the average expected energy savings which will be brought about by the installation of an energy saving device is calculated. Each installation is “deemed” to bring about this amount of energy saving and is funded accordingly.

It is known that each installation will not deliver the same degree of energy saving. It is also known that not all devices will remain installed for their full designed life. For a variety of reasons including householder dissatisfaction with the devices, and incompatibility with later purchase appliances, some units will be removed by the householder. The funding entity, which is funding the installation of energy saving devices in order to save energy, is motivated to ensure that it is only paying for energy savings which are actually delivered. Further, if the funding provided for the installation of a particular class of energy saving device is set at a level which undervalues the contribution made by that device relative to other funded energy saving devices or measures, then less of the undervalued devices will be installed, reducing the effectiveness of the expenditure by the funding entity.

Accordingly, in an embodiment, the monitoring entity may undertake to provide usage data for the energy saving device collected from each premises in which an energy saving device is installed.

Usage data is data which records how the energy saving device is actually performing or being used. In particular it will indicate if the device has been deinstalled. The usage data includes or enables calculation of the energy saving attributable to the installation of the energy saving device. This allows for monitoring and verification of the installation and of the deemed or claimed energy savings from the installation.

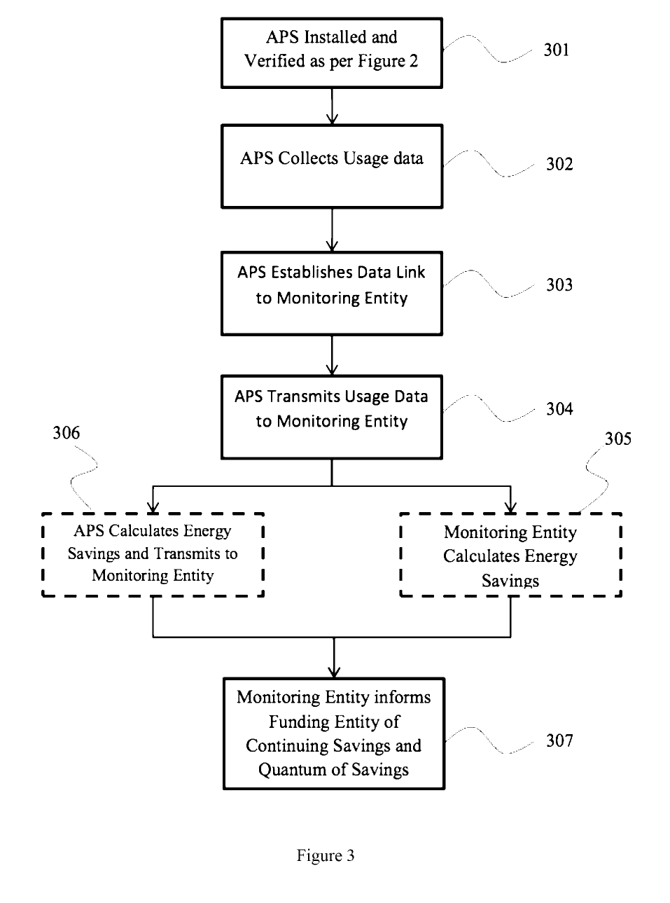

A method for providing the usage data where the energy saving device is an APS is shown in the flowchart of FIG. 3.

An APS of the type illustrated in FIG. 1 is installed in a premises and the installation is verified 301.

The APS operates normally within the household, removing power to the television and associated appliances when the television is not in active use. The APS collects 302 usage data describing the actions of the APS and the signals received. The APS data includes the power drawn through the APS, the occasions upon which power was withdrawn for low power standby and the occasions upon which power was withdrawn by Active Powerdown.

The APS establishes 303 a data link to the monitoring entity in order to transmit the usage data. In a preferred embodiment, this link is a Bluetooth link to a householder's smartphone or other computing device having internet access, the link to the monitoring entity being completed over the public internet.

In order for the APS to establish a Bluetooth link to a householder's smartphone or other mobile computing device, and from there to create a link to the monitoring entity, software such as an App or other software is made available on the computing device. In a preferred embodiment, the householder installs an App with this functionality on the householder's smartphone. Alternatively, the installer may have installed the App on the householder's phone at the time of installation. This App also serves as the user interface for the APS. The user interface displays the usage data and allows the user to control some functions of the APS, including manually switching power to the devices whose power is controlled by the APS.

In other embodiments, the APS may directly access an existing wi-fi network in the premises which has internet access. In other embodiments the APS may be adapted to have a wired network connection to a premises data network having internet access. In a further embodiment, all required software may be installed on the PAS, which is able to access the monitoring entity via the householder's mobile computing device without additional software, beyond the standard operating system software of the device, being required to be loaded on the householder's computing device.

The data link to the monitoring entity will be established when possible. Where more than one mobile computing device in a household has the require App installed, the APS may establish the link via any available device. It is likely that a suitable smartphone will not be available at all times.

The APS transmits 304 usage data to the monitoring entity over the link to the monitoring entity. Since the data link is not continuously available, the APS will store the usage data and transmit the data when the link is available.

In an embodiment, the monitoring entity uses the usage data to calculate 305 the energy savings which the APS is making. The data necessary for this calculation may be contained in the usage data, or data from the installation and premises data may be combined with the usage data for the calculation. The monitoring entity may then transmit the result of this calculation back to the smartphone for display to the householder on the APS user interface.

In an alternative embodiment, the APS, or the smartphone App, calculates 306 the energy savings from the usage data, and transmits this to the monitoring entity. The smartphone App having received the energy saving calculation result from the APS, or having made the calculation, displays the amount of energy saved by the APS to the householder via the APS user interface.

The monitoring entity now 307 transmits the information obtained from the usage data to the funding entity. This may be any or all of: an indication that the APS remains in use; the quantum of energy saved by the APS installation; and the full usage data.

The funding entity is now able to determine whether a particular installation is still in place, and the energy savings associated with the installation. The funding entity may have made some or all of the incentive payment it was to make for the installation contingent upon the ongoing results. For example, the monitoring entity or the installer may have financed the installation in the expectation of receiving an ongoing series of payments in proportion to the amount of energy saved by an installation. This payment may be made or withheld based on the results of the analysis of the usage data.

The funding entity may use the ongoing results to adjust the “deemed savings” values for future installations, even if payments for past installations are not affected. The funding entity may use the results to determine if a particular program to install a number of energy saving devices has been successful, and to decide whether to continue or repeat such a program.

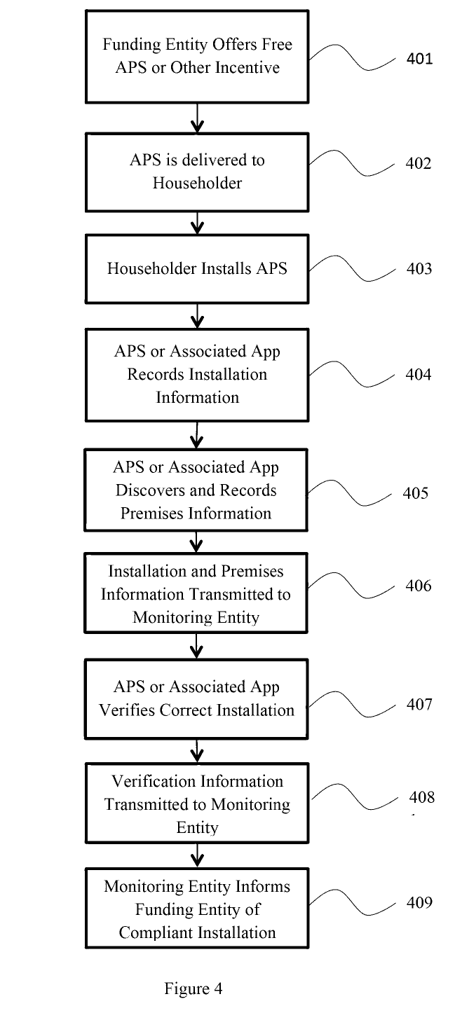

In an alternative embodiment, illustrated in FIG. 4, the installation of the energy saving device may be undertaken by the householder rather than by a professional installer. This method is suitable for energy saving devices requiring only simple installation where licensed tradespeople are not required to be used.

In this embodiment the funding entity makes an offer 401 of incentives for the installation of energy saving devices, in the illustrated embodiment, APS devices. The incentive may be the free or subsidised installation of the APS or any other incentive. The incentive may be a refund or partial refund of the purchase price of the APS for a compliant installation. The costs saving from the energy saving made by the APS is also an inherent incentive.

The householder then acquires 402 the APS. The APS may be delivered by courier, or post, or the householder may pick up the device from another location. The householder may purchase the APS from a store.

The householder then installs 403 the APS. In the case of the APS of FIG. 1, this is a simple procedure, requiring only the moving of the plug connections of the television and associated appliances.

As part of the installation, the householder makes provision for the APS to create a data link to the monitoring entity via the internet or other suitable network. In a preferred embodiment, this entails installing an App on a Bluetooth capable mobile computing device such as a smartphone. In other embodiments, the householder may make an existing wi-fi network available for connection, or connect the APS via a wired connection to an existing home network. The App provides a user interface for the APS. The App also provides a user interface to gather required data about the installation and premises.

The APS or the App then records 404 installation information being details of the installation, such as the number and type of appliances which are connected to the APS and the number of APS installed in the premises. This information may be acquired automatically by the App or the APS, or the householder may enter the data into the App.

The APS or the App then discovers and records 405 premises information. Premises information in this embodiment may be particularly important, since the funding entity may only be prepared to fund installations in particular geographic areas, or particular types of households. Where the funding entity is an energy supplier, the funding entity may only wish to subsidize installations by their own customers. Accordingly, identifying the energy supplier to the household may be critical.

The App may use the GPS capability or other geographic location capability of the device upon which it is running to establish the address or approximate address of the installation, which may be sufficient to establish the identity of the energy supplier.

Alternatively, all premises data may be entered by the householder.

The APS or the App then establish a data link to the monitoring entity to transmit 406 the installation and premises data to the monitoring entity. In a preferred embodiment the data link is a Bluetooth link to the device running the App, and the App the uses the internet connection of the device it is running on to make contact with the monitoring entity.

The APS or the associated App verifies 407 that the installation is correct and compliant with the requirements of the funding entity. In a preferred embodiment, the APS or the App perform one or more tests of the installation using the measurement and switching capabilities of the APS in order to establish that a correct installation has occurred. In alternative embodiments, contact between the APS and the App may be sufficient to indicate the APS has been installed. In other embodiments, the APS may monitor the load connected to it for some hours or days before the APS or the App have sufficient data to determine that the installation is compliant.

An indication of successful verification of the installation is provided 408 to the monitoring entity.

The monitoring entity then informs 409 the funding entity of the compliant installation. The monitoring entity may also provide any or all of the premises information and the installation information to the funding entity.

Ongoing transmission of usage data for a device installed by a householder is as described in FIG. 3, the same as for a professionally installed device. The monitoring entity and the funding entity make use of the data provided in the same manner.

The APS illustrated in FIG. 1 is a Tier 2 APS, capable of saving electricity in two ways. As described, passive power waste is eliminated by removing power from the television and associated appliances when the television is in a low power standby mode. The APS also saves energy by implementing Active Powerdown, when the television and associated appliances have power removed when a user is not actively using the television.

In an embodiment, the installed APS may be a Tier 1 APS. In this case, power is removed only from associated appliances when the television is in a low power standby mode. Power is not removed from the television, since, without the user presence detection associated with Active Powerdown, there is no convenient way to return power to the television. The APS returns power to the associated appliances when the television is returned to full power by user action.

In an alternative embodiment, the energy saving device to be installed in the premises may be an energy hub device. An energy hub device is a device which receives information about the flow of electricity into a household from an electricity supplier and receives data from one or more appliances describing the energy use of the appliance. The energy hub then displays or enables the display of this information to a householder. The energy hub may also calculate the optimum way in which appliances can be used to maximise energy savings. In embodiments, the energy hub is adapted to control appliances in order to implement this optimum use program.

Where reference has been made to infra-red remote controls and corresponding infra-red sensors, it will be understood that any form of remote control and corresponding sensors, including, without limitation, radio frequency remote controls, may be employed.

The invention has been described in terms of a residential entity, described as a household. However, the invention may be equally applied to commercial or factory entities, or any other discretely measurable, multi-load installation. The term “household” as used herein is intended also to cover such entities and installations.

Although the invention has been herein shown and described in what is conceived to be the most practical and preferred embodiments, it is recognised that departures can be made within the scope of the invention, which is not to be limited to the details described herein but is to be accorded the full scope of the disclosure so as to embrace any and all equivalent devices and apparatus.

1-16. (canceled)

17. A method for determining energy savings arising from installation of an energy saving device in a premises, the method including the steps of:
a. transmitting installation information to a monitoring entity, the installation information characterizing the installation of the energy saving device in the premises;
b. transmitting usage data to the monitoring entity, the usage data characterizing the ongoing power consumption of the energy saving device.

18. The method of claim 17 wherein the energy saving device is an advanced power strip.

19. The method of claim 17 wherein the energy saving device is an energy hub device.

20. The method of claim 17 wherein both:
a. the installation information, and
b. the usage data,
are transmitted to the monitoring entity by the energy saving device.

21. The method of claim 20 wherein the energy saving device is in communication with the monitoring entity via a Bluetooth wireless link.

22. The method of claim 20 wherein the energy saving device is in communication with the monitoring entity via a wi-fi wireless link available in the premises.

23. The method of claim 20 wherein the energy saving device is in communication with the monitoring entity via a mesh network wireless link.

24. The method of claim 17 further including the preceding steps of:
a. installing the energy saving device in the premises, wherein the premises is supplied with electricity:
(1) by an energy supplier, and
(2) at the request of an account holder;
b. verifying that the energy saving device is correctly installed in compliance with requirements of a third party.

25. The method of claim 24 wherein the third party is a funding entity which:
a. contributes to the cost of the installation of the energy saving device, and
b. is neither an owner or occupant of the premises.

26. The method of claim 24 further including the steps of:
a. recording premises information characterizing the premises;
b. transmitting the premises information to the monitoring entity; and
c. using the premises information to determine one or more of:
(1) the identity of the account holder, and
(2) the identity of the energy supplier.

27. The method of claim 24 further including the steps of the monitoring entity:
a. analyzing the usage data for compliance with a level of energy savings expected by the funding entity, and
b. reporting the results of the analysis to the funding entity.

28. The method of claim 27 further including the step of the funding entity using the results of the analysis to determine the amount of a payment to one or more of:
a. an installer who installed the energy saving device in the premises,
b. the account holder, and
c. the monitoring entity.

29. The method of claim 27 further including the steps of:
a. repeating the analysis of the usage data of claim 27 using usage data obtained from energy saving devices installed in several different premises;
b. using the results of the analyses to obtain an estimate of the success of the energy saving devices.

30. The method of claim 24 wherein the installer is one or more of:
a. the account holder,
b. a premises occupant,
c. an agent of the funding entity, and
d. an agent of the monitoring entity.

31. An advanced power strip configured to facilitate determination of energy savings arising from installation of the advanced power strip, the advanced power strip being configured to communicate:
a. installation information characterizing the installation of the advanced power strip within a premises, and
b. usage data characterizing the ongoing power consumption of the energy saving device,
to an external monitoring entity.

32. The advanced power strip of claim 31 further including a memory configured to store one or more of:
a. installation information,
b. usage data, and
c. premises data characterizing the premises.

33. The advanced power strip of claim 31 wherein the advanced power strip is configured to communicate the installation information and the usage data to the monitoring entity via a Bluetooth wireless link.

34. The advanced power strip of claim 31 wherein the advanced power strip is configured to communicate the installation information and the usage data to the monitoring entity via a wi-fi wireless link.

35. The advanced power strip of claim 31 wherein the advanced power strip is configured to communicate the installation information and the usage data to the monitoring entity via a wired connection.
